(19) United States
(12) Patent Application Publication
(10) Pub. No.: US 2021/0188617 A1
(43) Pub. Date: Jun. 24, 2021

(54) Fill Station, Cup Dispenser and Faucet Clip for Robotic Interaction

(71) Applicant: Evodyne Robotics Corporation, Mountain View, CA (US)

(72) Inventors: Brandon Kane Tarter, San Jose, CA (US); Annie Wang, Mountain View, CA (US); Raghav Gupta, Saratoga, CA (US)

(73) Assignee: Evodyne Robotics Corporation, Mountain View, CA (US)

(21) Appl. No.: 17/130,876

(22) Filed: Dec. 22, 2020

Related U.S. Application Data
(60) Provisional application No. 62/953,085, filed on Dec. 23, 2019.
(60) Provisional application No. 62/952,992, filed on Dec. 23, 2019.
(60) Provisional application No. 62/953,052, filed on Dec. 23, 2019.

(51) Int. Cl. B67D 7/84; B67D 7/08; B25J 9/16

(52) U.S. Cl. CPC B67D 7/845; B25J 9/1694; B67D 7/08

(57) ABSTRACT

Fill stations, cup dispensers and faucet clips configured for robotic interaction and associated methods and systems are disclosed herein. One disclosed system includes a robot with a visible light sensor and an end effector, a mechanical scale for weighing a vessel, and a visual flag translated by the mechanical scale. The visual flag is hidden when the vessel is below a target weight and is revealed when the vessel is above a target weight. The robot is programmed to detect the visual flag using the visible light sensor and disengage a dispenser of the fill station in response to the detecting of the visual flag.

### CROSS REFERENCE TO RELATED APPLICATIONS

This application claims the benefit of U.S. Provisional Patent Application No. 62/953,085, filed Dec. 23, 2019, U.S. Provisional Patent Application No. 62/952,992, filed Dec. 23, 2019, U.S. Provisional Patent Application No. 62/953,052, filed Dec. 23, 2019, all of which are incorporated by reference herein in their entirety for all purposes.

### BACKGROUND

Robots can be custom designed for specific applications in which the application itself has also been designed to operate with the robot. These applications are said to be executed within structured environments meaning the environment has been formed specifically for interaction with a robot. The quintessential structured environment for robots is the assembly line in which a robot can be highly specialized and designed exclusively to conduct a single action on the work piece of the assembly line. On the other end of the spectrum lie unstructured environments which have not been designed to interact with the robot in any manner. An example of an unstructured environment is a common household in which the environment has been designed for human interaction as opposed to robotic interaction. Between these two extremes are semi-structured environments in which the environment has been modified to facilitate the operation of a robot but was not designed from the ground-up to facilitate the robot's operation. Certain aspects of the field of semi-structured environments overlap in part with the field of disabled assistance environments as disabled human users and robots can both generally benefit from modifications intended to make an environment easier to manipulate or interact with.

### SUMMARY

This disclosure relates to robots generally and specifically to fill stations configured for robotic interaction. The fill station can be configured to dispense a fill material. The robot can be configured to retrieve the fill material from the fill station using a vessel. The fill station can be a human-centric fill station, such as a traditional water cooler, which has been augmented to be operated by a robot. The robot can be mobile and can be programmed to navigate to the fill station, use the fill station to obtain the fill material, and navigate to where the fill material is required.

In specific embodiments of the invention, a method is provided for robotic retrieval of a fill material. The method includes navigating a robot to a fill station. The fill station includes a scale and contains the fill material. The method also includes placing, using the robot, a vessel on the scale. The method also includes engaging, with the robot, a dispenser of the fill station. The method also includes triggering, when the weight of the vessel as measured by the scale reaches a target state, a flag. The method also includes disengaging, with the robot and in response to the flag, the dispenser of the fill station. The method also includes retrieving, using the robot, the vessel from the scale. The robot can then navigate to provide the vessel with the fill material to where it is required.

In specific embodiments of the invention, a device is disclosed. The device can be used to augment a fill station for robotic interaction. The device includes a mechanical scale for holding a vessel, and a visual flag translated by the mechanical scale. The visual flag is hidden when the vessel is below a target weight. The visual flag is revealed when the vessel is above a target weight.

In specific embodiments of the invention, a system is disclosed. The system includes a robot with a visible light sensor and an end effector, a mechanical scale for holding a vessel, and a visual flag translated by the mechanical scale. The visual flag is hidden from the visible light sensor when the vessel is below a target weight. The visual flag is revealed to the visible light sensor when the vessel is above a target weight. The robot is programmed to detect the visual flag using the visible light sensor and disengage a dispenser in response to the detecting of the visual flag.

Another aspect of the present disclosure relates to dispensers generally and specifically to vessel dispensers configured for robotic interaction. A dispenser can be configured to dispense a vessel such as a single use cup. A robot can be configured to actuate the dispenser and retrieve a vessel from the dispenser. In specific embodiments of the invention, the dispenser can be actuated and cause a single vessel to be dispensed using a pull, push, twist, or any basic action. The basic action can involve a single range of motion that actuates a carriage along a slide track. The robot can be mobile and can be programmed to navigate to the dispenser, use the dispenser to obtain a vessel, and then navigate to a fill station with the vessel. The dispenser can be marked with an encoding to assist the robot in navigating to the dispenser. The same encoding could also be used by the robot to assist in actuating the dispenser.

In specific embodiments of the invention, a device for dispensing a vessel is disclosed. The device comprises a slide track, a carriage on the slide track, a first platform on the carriage, and a second platform on the carriage. The second platform overlies a first portion of the first platform, does not overlie a second portion of the first platform, and is separated from the first platform at the first portion by a gap. The device can be configured to allow a single vessel to be dispensed from the device via the gap when the carriage is actuated on the slide track.

Another aspect of the present disclosure relates to robots generally and specifically to faucet clips for robotic interactions.

In a specific embodiment of the invention, a device is provided. The device comprises a clip having: (i) a planar main body; (ii) a first clip jaw located on a first end; and (iii) a second clip jaw located on a second end. The device also comprises a handle connected to an outside edge of the first clip jaw. The main body, first clip jaw, and second clip jaw are sized to attach the device to a fill station dispenser.

In a specific embodiment of the invention, a device is provided. The device comprises a clip having: (i) a main body separating a first end from a second end by at least 5 millimeters; (ii) a first clip jaw located on the first end; and (iii) a second clip jaw located on the second end. The device also comprises a handle: (i) connected to the first end; and (ii) positioned to exert, when actuated, a force that compresses the first clip jaw.

In a specific embodiment of the invention, a device is provided. The device comprises a means for connecting to a fill station dispenser. The means for connecting disclosed herein can be a clip, adhesive, fastener (e.g., screw, bolt, nail, tack), latch, catch, clasp, buckle, or any other means for connecting two elements. The device also comprises a handle connected to the means for connecting, and a target holder attached to the handle. The target holder and the handle form an angle greater than forty-five degrees.

### BRIEF DESCRIPTION OF THE DRAWINGS

FIG. 1 illustrates two perspective views of a device in the form of an augmentation for a fill station that are in accordance with specific embodiments of the invention disclosed herein.

FIG. 2 illustrates additional views of the device in FIG. 1.

FIG. 3 illustrates a visual flag in two states, a revealed state and a hidden state, in accordance with specific embodiments of the invention disclosed herein.

FIG. 4 illustrates two perspective exploded views of the device in FIG. 1 and a detailed view of a calibration device of the device in FIG. 1.

FIG. 5 illustrates a fill station in accordance with specific embodiments of the invention disclosed herein.

FIG. 6 illustrates a fill station, robotic end effector, and cup dispenser in accordance with specific embodiments of the invention disclosed herein.

FIG. 7 illustrates a cross section of a carriage of a device for dispensing a vessel and the same cross section being used to dispense a vessel from a stack of vessels in accordance with specific embodiments of the invention disclosed herein.

FIG. 8 illustrates a top down perspective view of a carriage of a device for dispensing a vessel in accordance with specific embodiments of the invention disclosed herein.

FIG. 9 illustrates a perspective view of a device for dispensing a vessel in accordance with specific embodiments of the invention disclosed herein.

FIG. 10 illustrates a cross section of a carriage of a device for dispensing a vessel with a clip spanning a gap between a first and second platform in accordance with specific embodiments of the invention disclosed herein.

FIG. 11 includes a perspective view of a faucet clip for robotic interaction that is in accordance with specific embodiments of the invention disclosed herein.

FIG. 12 includes a second perspective view of the faucet clip in FIG. 11.

FIG. 13 includes a side view of the faucet clip in FIG. 11 along with a standard water cooler tap to illustrate the interconnection of the two in accordance with specific embodiments of the invention disclosed herein.

### DETAILED DESCRIPTION

Systems and methods involving fill stations configured for robotic interaction in accordance with the summary above are disclosed below. The specific embodiments of these systems and methods disclosed in this section are provided for explanatory purposes and are not meant to limit the invention, the scope of which is provided by the appended claims. The systems disclosed herein can include mobile robots configured to navigate to the fill station, obtain fill material therefrom, and then navigate to where the fill material is required. A mobile robot obtaining potable water from a water cooler is used throughout this disclosure as an illustrative example of the disclosed systems and methods. However, the disclosed systems and methods are more broadly applicable to any type of fill station and fill material.

In specific embodiments of the invention, a fill station is configured for robotic interaction. The fill station can be configured to dispense a fill material. The fill station can be unmetered, meaning that it dispenses a fill material when a dispenser of the fill station is engaged and does not stop automatically or keep track of how much material has been dispensed while the dispenser is engaged. In these environments, the agent which is operating the dispenser must conduct the metering action. As such, unmetered fill stations capable of robotic interaction require the robot to conduct the metering action and determine when the dispenser should be engaged and disengaged.

If an unmetered fill station dispenses fill material at a controlled and known rate, a robot can conduct the metering action using a basic timer (e.g., a dispenser with a known rate of 2 gallons per minute engaged, as measured by a timer, for 30 seconds can be assumed to dispense 1 gallon). However, if the unmetered fill station dispenses fill material at an unknown rate, this approach will not work. For example, a water cooler will dispense water more rapidly if the water tank is full as compared to when the water tank is nearly empty. Regardless, different water coolers dispense water at different rates based on a myriad of other factors, and it would be less useful to program a robot to only work with a single water cooler.

Furthermore, in specific application, it may be difficult to directly monitor the amount of fill material that has been dispensed from a fill station using a visual computer vision system. For example, certain fill materials such as water may be difficult to segment and analyze due to the fact that the “full” portion of a vessel containing transparent clear water is visually similar to the “empty” portion of the vessel. As another example, a vessel may be opaque making it difficult to determine the amount of fill material using visible monitoring.

In specific embodiments of the invention, the above-mentioned difficulties are obviated by making semi-structured environment augmentations to an existing fill station to include a device that measures the weight of a vessel and triggers a flag when the vessel reaches a target weight. The device can include a scale for holding the vessel and a flag triggered when the weight of the vessel as measured by the scale reaches a target weight. The scale can hold the vessel on a platform which can be a featureless plain or include one or more indentations to support vessels placed therein. The device can be part of a system which includes a robot that can engage a dispenser of the fill station and disengage the dispenser in response to the flag. The robot can be a mobile robot configured to navigate to the fill station and engage the dispenser of the fill station. The dispenser may also include an augmentation in order to be more easily manipulated by a robot. In specific embodiments of the invention, the dispenser is specifically designed for manipulation by the robot. In specific embodiments of the invention, the robot can also be configured to obtain a vessel for placement on the fill station. The vessel may be provided by a vessel dispenser. The vessel dispenser may also include an augmentation in order to be more easily manipulated by a robot. In specific embodiments of the invention, the vessel dispenser is specifically designed for operation by the robot. The vessel could be a drinking container such as a cup and the vessel dispenser could be a cup dispenser.

Depending upon the specific embodiment of the invention, the scale of the fill station can take on various forms. The scale can be a mechanical scale where the weight of the item is determined by how far a meter of the scale is translated in response to a weight placed on the scale. Such mechanical scales include spring compression scales, balance scales, and hydraulic or pneumatic scales. The scale could alternatively be an electronic scale such as a digital strain gauge scale in which the weight of the item is determined by a change in current affected by the weight of the item on the scale. The scale could also be a hybrid scale of any of the types mentioned above. The specific scales that may be used in any given implementation will be affected by what kind of flag is triggered when a vessel placed on the scale reaches a target weight as will be apparent from the following disclosure. In embodiments in which the fill material is a liquid, mechanical scales may offer a particular benefit in that they are less susceptible to damage from liquid than electronic scales.

Depending upon the specific embodiment of the invention, the flag which is triggered when the weight of the vessel, as measured by the scale, reaches the target weight can take on various forms. The flag could be binary or gradated. Binary flags could be in one state when the weight of the vessel was below the target weight and a second state when the weight of the vessel was at or above the target weight. For example, the flag could be in a visible state when the weight was above a target weight and a hidden state when the weight was below a target weight. Gradated flags could include additional information regarding the amount of fill material in the vessel such that the flag indicates multiple target weights or fractions of a single target weight as the vessel was gradually filled. A single gradated flag could also be replaced by multiple binary flags to encode various gradation based on the multiple potential states of the combined set of binary flags.

In specific embodiments of the invention, the flag can be a mechanical flag. The robot can include a visual light sensor to detect the appearance of the mechanical flag or a pressure or touch sensor that can engage with the mechanical flag. For example, the flag could be a rigid member that lifts away from a surface of the fill station to encounter a pressure sensor on the body of the robot to indicate that the target weight has been reached. Although the example of a single flag is used as an illustrative example throughout this disclosure, characterizations regarding a single flag can also be applied to systems with multiple flags.

In specific embodiments of the invention, the flag can be a visible flag. For example, the flag could be a light source such as an LED that illuminates, flashes, or turns off when the target weight is reached, a display that shows an encoding, pattern, or symbol when the target weight is reached, or a mechanical flag with an encoding, pattern, or symbol that is hidden when the target weight is not reached and is revealed when the target weight is reached (or vice versa). The robot could include a visible light sensor or a depth sensor in order to detect the flag and respond thereto. The visual flag could be a two or three-dimensional marker. The visual flag could include a fiducial marker. In specific embodiments of the invention, the visual flag could be configured for easy detection by a computer vision system. For example, the visual flag could be monochromatic and could have few edges. The visual flag could be a two-dimensional encoding. The encoding could be encoded in variant spatial patterns of black and white. The visual flags could be AprilTags, QR Barcodes, Aztec, MaxiCode, Data Matrix or ArUco markers.

In specific embodiments of the invention, the flag can be a wireless flag. The flag can be a wireless flag transmitted by a wireless transmitter of the fill station. The wireless signal could be a radio frequency, infra-red, or ultra-violet signal. The robot can have a wireless receiver to respond to the flag. For example, the wireless flag can be a signal sent over a Bluetooth, Zigbee, Z-Wave, or Wi-Fi connection from the scale to the robot. The wireless flag could also be an NFC or RFID signal sent from the fill station to the robot. The wireless flag could also be sent using an infrared or ultraviolet signal transmitted from the fill station to an infra-red or ultra-violet receiver on the robot.

In specific embodiments of the invention, the fill station will include multiple target weights. For example, the different target weights could be set to indicate when a vessel was half-way full as opposed to completely full. This would allow a robot to retrieve differing amounts of fill material. The different target weights could involve the display of different flags. For example, a first flag could be triggered when the first target weight was exceeded, and a second flag could be triggered when the second target weight was exceeded. In embodiments in which the flags include encodings (e.g., QR codes) the encodings could indicate which target level had been reached. Alternatively, if the flag were a gradated flag, the gradations could indicate which target level had been reached. For example, the gradated flag could include multiple encodings that were gradually revealed as the weight increased, with the full revelation of a given encoding indicating that the relevant target weight had been reached.

In specific embodiments of the invention, the scale can trigger the flag in various ways. For example, if the scale is electronic, an electronic signal could be sent to an actuator to operate a mechanical flag or to a wireless transmitter to transmit a wireless flag. As another example, if the scale is mechanical, an actuator could translate the motion of the scale to trigger the flag. In embodiments in which the scale was a mechanical balance or compression scale, the downward motion of the scale in response to an increase in weight could be translated by an actuator to lift a visual flag up from behind a barrier. The actuator could be calibrated so that the visual flag was fully visible when the target weight was reached. The flag could fall back down to a pensive state when the weight was removed from the scale. In similar embodiments, the downward motion of the scale could be translated by an actuator to rotate or pull down a visual flag from behind a barrier. The actuator could be calibrated so that the visual flag was fully visible when the target weight was reached. The flag could be rotated back around or lifted up under the force of a spring or other responsive element when the weight was removed from the scale. In specific embodiments of the invention, the weight of the flag or the responsive element mentioned in the embodiments above could serve as the counterweight of a balance scale. In another example, the actuator could be configured to close a circuit when the target weight was reached. For example, the actuator could include a metallic or other conductive element which would be brought into contact with two jump pads in a circuit when the target weight was reached. The circuit could be communicatively connected to the flag or an actuator used to trigger the flag. For example, closing the circuit could cause an electronic actuator to deploy a flag, light an LED, or instruct a wireless transmitter to transmit a wireless flag.

In specific embodiments of the invention, the target weight or target weights can be calibrated. The target weight can be calibrated using a mechanical or electronic calibrator. For example, the mechanical actuator mentioned in the previous paragraph could have a range of motion proportional to the weight placed on the scale and the proportion could be adjustable using a dial or other mechanical element on the scale. As another example, the distance of a counterweight in a balance scale from the fulcrum could be adjusted by the calibrator to set the target weight. As another example, the weight of the counterweight could be adjusted to set the target weight. The target weight could also be a programmable value in an electronic scale. In embodiments in which the system included multiple target weights each target weight could be individually calibrated. The target or targets could be calibrated based on the characteristics of the fill material for a given fill station (e.g., a cereal dispenser would have a lower target weight than a liquid dispenser given the lower density of the fill material). The target or targets could also be calibrated based on a desired fill level of fill material and the characteristics of the vessel used to obtain the fill material. In specific embodiments of the invention, calibration could include placing a vessel with the desired level of fill material on the scale and adjusting a mechanical or electronic calibrator until the flag was just triggered.

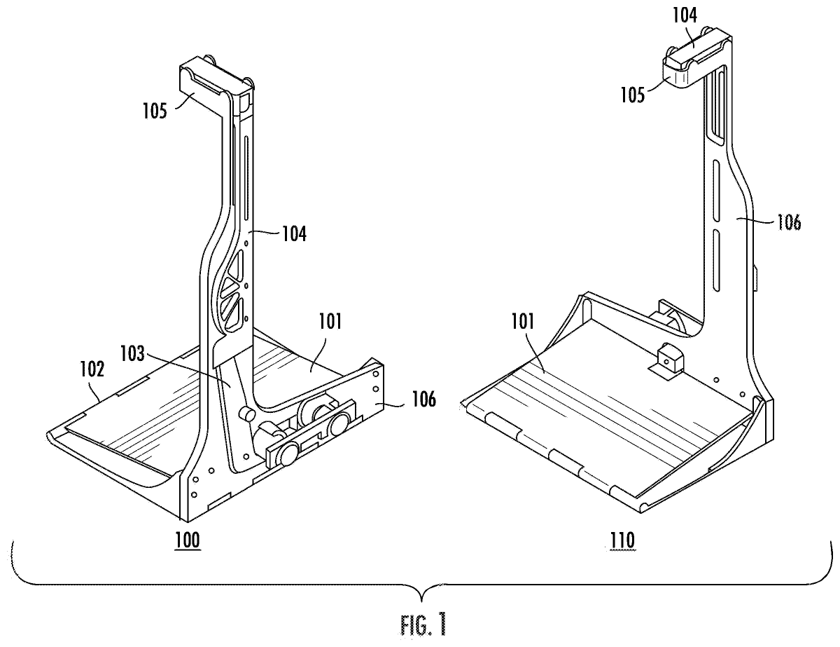

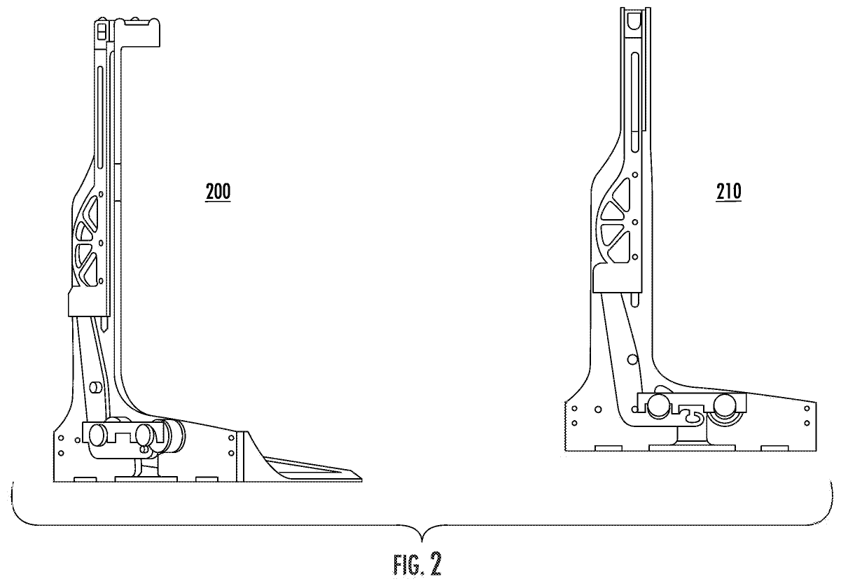

FIG. 1 illustrates two perspective views 100 and 110 of a device in the form of an augmentation for a fill station that are in accordance with specific embodiments of the invention disclosed herein. The device comprises a scale in the form of a balance scale. The balance scale includes platform 101 on which a vessel can be placed. Platform 101 can experience a motion downward and can swing around hinge 102. Platform 101 is kept elevated when the scale is empty. Platform 101 is connected to actuator 103. Actuator 103 is in turn connected to flag 104 which is weighted to rest on perch 105. In the illustrated case, actuator 103 forms a cam which amplifies the movement of the platform relative to the resulting movement in the flag. When the weight of a vessel placed on platform 101 becomes sufficient, the downward motion of platform 101 lifts flag 104. The device includes a tower element 106 used to support perch 105 at a sufficient height so as to render flag 104 visible above any vessel that may be placed on platform 101 and any portion of the fill station (e.g., the dispenser) or any portion of a mobile robot (e.g., an end effector grasping the dispenser) that would otherwise block the view of flag 104. FIG. 2 illustrates two additional views 200 and 210 of the device in FIG. 1.

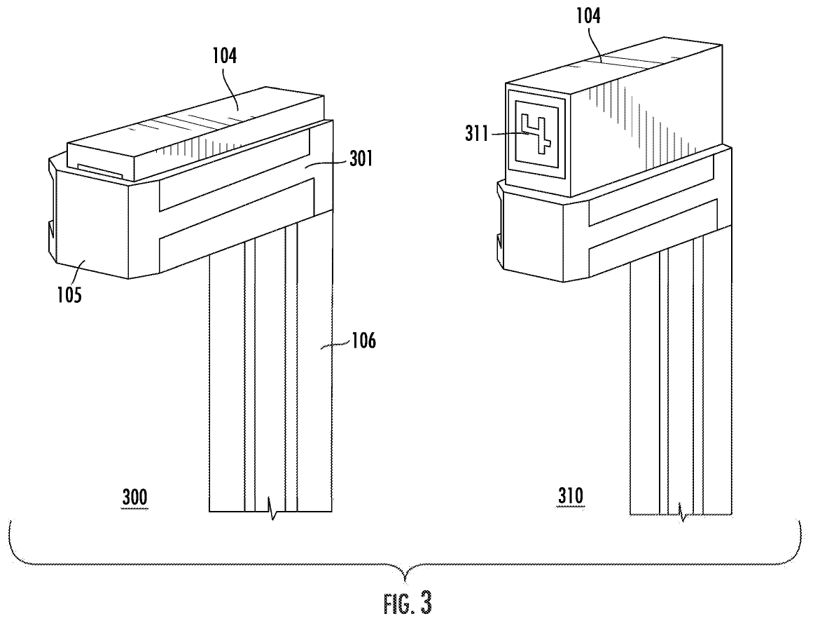

FIG. 3 illustrates a visual flag in the form of flag 104 with a two-dimensional encoding 311 in two states, a revealed state 310 and a hidden state 300, in accordance with specific embodiments of the invention disclosed herein. Flag 104 can be configured as in FIG. 1 such that it is raised when the weight placed on the scale becomes sufficient. In particular, the scale can be calibrated such that the entire encoding 311 becomes visible when the weight becomes sufficient. In specific implementations, the encoding 311 can become visible when the platform 101 has been fully depressed and rests on the base of the device. As illustrated, the tower 106 of the scale can be integral with perch 105 and also includes perch sidewalls such as sidewall 301. The sidewall serves to keep the flag 104 in line with the device as the flag is raised and lowered since the flag is approximately the width of the channel formed by the sidewalls and is slightly taller than the depth of the channel. A robot with a visible light sensor and a computer vision system can then detect encoding 311 to determine that the flag 104 has been triggered, and the vessel has reached the target weight, to then disengage the dispenser of the fill station.

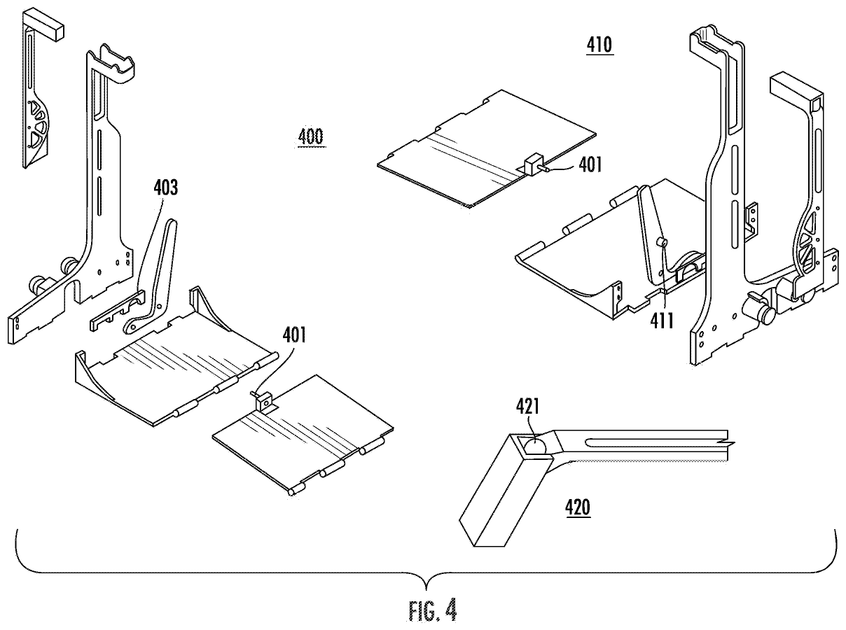

FIG. 4 illustrates two perspective exploded views 400 and 410 of the device in FIG. 1 and a detailed view of a mechanical calibrator 420 of the device in FIG. 1. The exploded views 400 and 410 show how the various components of the device work in combination. For example, exploded view 400 shows pin 401 which connects the platform 101 to actuator 103. Exploded view 400 also shows cross bar 403 which keeps actuator 103 secured against tower 106. Exploded view 410 shows notch 411 which allows for the translation of motion from the platform 101 to flag 104. Detailed view 420 shows a mechanical calibrator in the form of pocket 421 which can be loaded with weights to calibrate the target weight of the scale. As illustrated, pocket 421 is formed in flag 104 with an opening opposite encoding 311. The weights can be standardized elements sized to rest within pocket 421 and be ejected using a magnet or by simply tilting the device. Pocket 421 can include a snap on cover to keep the weights in place after calibration. Alternatively flag 104 can be one of multiple potential flags to use with the fill station where each is weighted to operate with a specific type of fill material. Configuring the device for a particular fill station would thereby require selecting and installing the appropriately weighted flag.

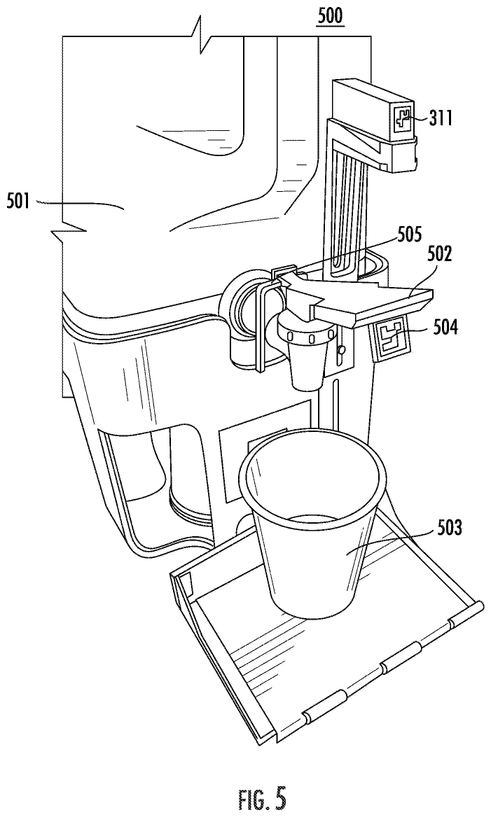

FIG. 5 illustrates a fill station 500 in accordance with specific embodiments of the invention disclosed herein. Fill station 500 has been augmented with the device from FIG. 1 in order to allow a robot with a computer vision system to easily meter the fill material. In the illustrated case, the fill material is water and the fill station is a water cooler. Fill station 500 includes a water tank 501 with a dispenser tap in the form of an augmented water cooler tap. The augmentation could be a faucet clip as described below and in accordance with the disclosure in U.S. Patent Application No. 62/953,052 filed on Dec. 23, 2019 and incorporated by reference herein in its entirety for all purposes. The augmentation renders the dispenser 502 more easily manipulated by a robotic gripper and includes an encoding 504 used to mark the dispenser 502. Encoding 504 can be in the form of a sticker that a computer vision system of a robot can find, recognize, and lock on to in order to align the gripper with the dispenser. As illustrated, encoding 311 is of the same type as encoding 504. However, the encodings are different such that the robot can recognize one indicates the presence of a dispenser and the other indicates that the fill station includes a full vessel. FIG. 5 also illustrates a vessel 503 in the form of an opaque cup filled with water. As shown, encoding 311 is displayed far above dispenser 502 and vessel 503 so that even when a potentially large robotic gripper or other end effector is engaged with dispenser 502, the view of the flag and encoding 311 is not blocked.

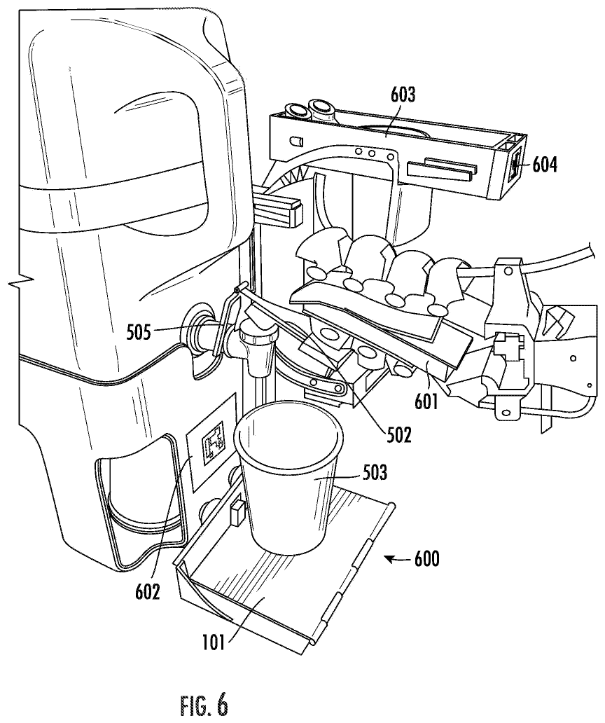

FIG. 6 illustrates a fill station 600, robotic end effector 601, and cup dispenser 603 in accordance with specific embodiments of the invention disclosed herein. As illustrated, the fill station 600 is in accordance with the fill station of FIG. 5 as augmented by the device in FIG. 1. However, FIG. 6 also illustrates an encoding 602 in the form of a sticker which indicates to a computer vision system the location of the platform 101 of the fill station. In specific embodiments of the invention, a mobile robot with control of end effector 601 will be programmed to use that same appendage to both operate the dispenser 502 and to place vessel 503 on platform 101. The mobile robot can use encoding 602 in order to guide that placement. Additionally, the robot can be programmed to retrieve vessel 503 from a cup dispenser as a subtask of retrieving fill material from fill station 600. As illustrated, the mobile robot can retrieve a cup from a vessel dispenser in the form of cup dispenser 603. The cup dispenser 603 can include an encoding 604 in order to provide the robot with a target to operate cup dispenser 603. Encoding 604 and 602 can be of the same type as encoding 311 and encoding 504. The robot can be programmed to operate the cup dispenser and pick up the cup using the same appendage as is used to operate the fill station (e.g., end effector 601 in the illustrated case).

Systems and methods involving dispensers configured for robotic interaction in accordance with the summary above are disclosed below. The specific embodiments of the systems and methods disclosed in this section are provided for explanatory purposes and are not meant to limit the invention, the scope of which is provided by the appended claims. The systems disclosed herein can include mobile robots configured to navigate to the dispenser, obtain a vessel therefrom, and then navigate to a fill station with the vessel. A mobile robot obtaining a single use cup from a cup dispenser is used throughout this disclosure as an illustrative example of the disclosed systems and methods. However, the disclosed systems and methods are more broadly applicable to any type of dispenser. Furthermore, specific embodiments of the invention disclosed herein are broadly applicable to facilitate use of a dispenser by any user whether robotic or human.

In specific embodiments of the invention, a device for dispensing vessels includes a slide track and a carriage on the slide track. The carriage can be actuated along the slide track in order to dispense a vessel from the dispenser. The actuation of the slide track can involve a simple motion such as a push, pull, or twist. That actuation can be conducted by a robot such as via a pushing motion from a robotic end effector. The carriage can include a large target for receiving contact from the robot in order to receive the force used to actuate the slide track. The carriage could include a target in the form of a specialized adapter for connecting to a particular robotic end effector or could be a more generalized target such as a large flat target area or a large surface with a divot for affording purchase against a generalized class of end effectors. The actuation of the slide track can involve translation of the slide track from a start point to an end point. The end point and start point can be hard stops for the carriage, meaning that the carriage runs out of slide track at that point, or that some other element prevents the carriage from moving along the track at that point. Alternatively, the end point can be a point at which the dispensing action of the carriage has been conducted regardless of the presence of a hard stop.

In specific embodiments of the invention, the device can be configured to dispense a single vessel in response to an actuation of the slide track from the start point to the end point, and back to the start point. The device can be configured to automatically reset after actuation. In these embodiments, a robot designed to interact with the dispenser only needs to be programmed to conduct a single action to dispense a vessel as the device will essentially be reset after a single vessel has been dispensed. In specific embodiments of the invention, the device can include an elastic actuator connected to the carriage. The elastic actuator can force the carriage towards the start point to reset the carriage to the start position. The elastic actuator could be a spring, the load mechanism of one or more retracting cables, an elastic cord or loop (e.g., a rubber band), memory material (e.g., memory foam), and any other elastic device or material that returns to its position after being forced into another. In the alternative or in combination the device can be configured to reset the carriage to the start position using alternative means such as via the force of gravity (e.g., by using a sloped track or by using a counterweight) or the electromagnetic force (e.g., by using magnets). Embodiments in which the device resets the carriage automatically afford an even greater degree of robotic usability in that a full cycle of interaction only requires a single range of motion on the part of the robot.

In specific embodiments of the invention, the device can be configured to dispense vessels by passing them through a gap in a platform as a carriage is actuated along a slide track. The platform can be on the carriage. In specific embodiments of the invention, the device can be configured such that a stack of vessels will have a natural tendency to be dispensed from the dispenser but are locked into the dispenser by a platform. For example, a stack of vessels could be suspended in air such that they should naturally fall out of the dispenser via the force of gravity if not for the aforementioned platform preventing them from falling. As another example, a stack of vessels could be spring loaded to be ejected upwards out of the dispenser via the force of the spring if not for the aforementioned platform preventing them from being ejected. In specific embodiments of the invention, the device is configured so that only a single vessel passes through the aforementioned gap when the carriage is actuated.

In specific embodiments of the invention, the carriage will include at least two platforms which are configured to separate out a single vessel from a stack of vessels using a gap between the platforms. The platforms can be configured to support a non-homogenous element of the vessel. The non-homogenous element can be an element that locally increases the cross section of the vessel. The non-homogenous element can be an element that is presented when the vessel is in a stack even when the vessel is not on an end of the stack. In the particular case of a vessel being a lipped cup, the non-homogenous element could be the lip of the cup. In embodiments using two platforms in the form of a first platform and a second platform, the first platform can be configured to support all the vessels in the vessel stack when the carriage is at the start point, and the second platform can be configured to support all vessels in the vessel stack except for the next vessel to be dispensed (e.g., the lowest vessel when vessels are dispensed from the bottom of the stack) when the carriage is at the end point. During actuation of the carriage, the next vessel to be dispensed can slip through a gap between the first platform and the second platform. The first platform can be configured to lock in the vessels when the carriage is at the start point and not lock in the vessels when the carriage is at the end point. The second platform can be configured to lock in the vessels (except for the dispensed vessel) when the carriage is at the end point.

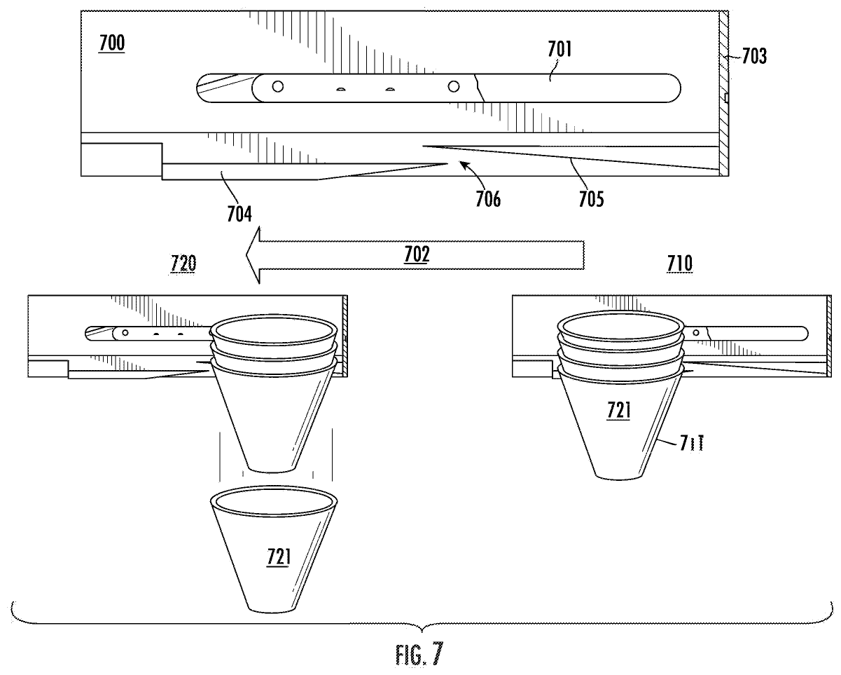

FIG. 7 illustrates a cross section of a carriage 700 of a device for dispensing a vessel and the same cross section being used to dispense a vessel from a stack of vessels in accordance with specific embodiments of the invention disclosed herein. Carriage 700 includes slide track 701 and is configured to be actuated by a pushing motion in the direction of arrow 702 as applied to carriage 700 on target surface 703. Carriage 700 also includes two platforms, a first platform 704 and a second platform 705. As illustrated, second platform 705 overlies a first portion of first platform 704 and does not overly a second portion of first platform 704. Additionally, first platform 704 is separated from second platform 705 by a gap 706. The carriage is configured to allow for a vessel to be dispensed when the carriage is actuated from a first position to a second position. The vessel can be dispensed by slipping through gap 706 when the carriage is actuated while the remainder of the vessels do not.

FIG. 7 includes two views 710 and 720 that show the same cross section of carriage 700 but with the carriage located at a start point in view 710 and an end point in view 720. The carriage is translated between the two states using a motion illustrated by arrow 702. In the illustrated case, the vessel 721 is a lipped cup in a stack of vessels 711 in the form of a stack of lipped cups. The vessel 721 is dispensed when the carriage is translated from the start point to the end point. As illustrated, the first platform 704 does not underly a portion of the second platform 705. As shown by comparing view 710 and 720, the aforementioned portion of the second platform 705 translates past the vessel when the carriage is actuated from the start point to the end point. The first platform is configured to support all the vessels in the stack of vessels 711 when the carriage is at the start point. The second platform 705 is configured to support all the vessels in the stack of vessels 711 except for the lowest vessel to be dispensed 721 when the carriage is at the end point, as vessel 721 drops away from the dispenser and is dispensed. When the carriage returns to the start point (whether automatically or via a manual motion applied to the device) the stack of vessels 711 less one will be transferred back to the first platform 704.

In specific embodiments of the invention, a gap between a first platform and a second platform of a device is sized to dispense a single vessel from the dispenser. In the illustrated case of FIG. 7, the gap 706 is sized to be less than twice the height of the lip of a single lipped cup. In alternative embodiments in which the platforms support alternative features of the individual vessels, the gap can still be sized to only permit one of those features through during a single actuation of the carriage.

In specific embodiments of the invention, the carriage can be formed to follow different slide track patterns in order to dispense a vessel. The slide track could follow a straight line tangential to a location the vessel is dispensed from. With reference to FIG. 7, the straight line could be the line indicated by arrow 702. The slide track could alternatively follow an arch around a location the vessel is dispensed from. An arched slide track could be utilized when the motion used to actuate the dispenser was a twisting motion. The slide track could generally follow any pattern required to guide a gap between two platforms of the carriage to allow a feature of one vessel to slip through the gap while the remainder of the vessels in the dispenser do not.

In specific embodiments of the invention, the dispenser can include multiple sets of platforms. For example, the cross section of FIG. 7 could be matched by an approximately mirror image configuration so that the vessels are supported from both sides by platforms attached to the carriage configured to allow the vessels to slip through a gap in the platforms. In the case of an arched slide path, the vessel could be supported from multiple portions of an arch using different sets of platforms each with their own gaps to allow for vessels to be dispensed.

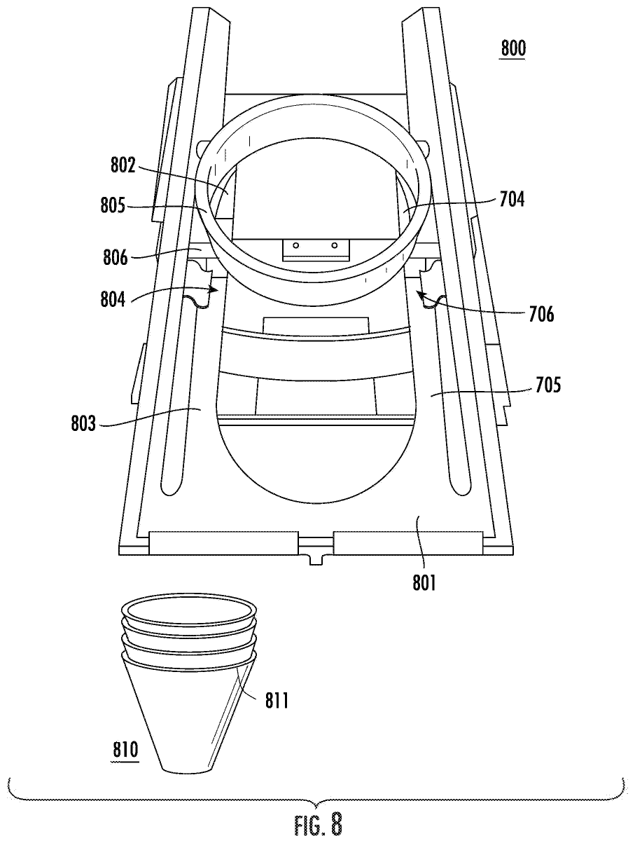

FIG. 8 illustrates a top down perspective view 800 of a carriage 801 of a device for dispensing a vessel in accordance with specific embodiments of the invention disclosed herein. Like elements from FIG. 7 are marked with identical reference numbers. As illustrated, the vessels can be a stack of lipped cups 810 where gap 706 permits lip 811 but does not permit the lips of any of the other cups in the stack of lipped cups 810. Carriage 801 additionally includes a third platform 802 and a fourth platform 803. Platform 803 and platform 705 in FIG. 2 form a continuous region of material as they are connected by a bridge towards the front of carriage 801. The bridge serves as an end point for the carriage as it will come into contact with the stack of cups when the device is fully depressed. Fourth platform 803 overlies a first portion of third platform 802, does not overly a section portion of the third platform 802, and is separated from third platform 802 by a second gap 804. Second gap 804 can have the same characteristics as gap 706. Likewise, third platform 802 can have the same characteristics as first platform 704 and fourth platform 803 can have the same characteristics as second platform 705. As illustrated, the first platform 704 and second platform 705, and the third platform 802 and fourth platform 803, are on opposite sides of carriage 801.

In specific embodiments of the invention, the device will include a vessel stabilizer to prevent the vessels in the dispenser from tilting in response to the actuation of the carriage. The vessel stabilizer can be separate from the carriage such that it provides a brace to the vessels against the movement of the dispenser. As illustrated in FIG. 8, the device includes a vessel stack stabilizer 805 that is separate from carriage 801. The vessel stack stabilizer 805 is instead connected to a support 806. In specific embodiments, such as the one illustrated in FIG. 8, a support used to support the vessel stabilizer can also serve as a support for the slider track of the carriage. As illustrated, support 806 is threaded through the slider track of carriage 801.

In specific embodiments of the invention in which a vessel drops away from a carriage when dispensed, the device can be supported by a base. The base can include legs that hold the carriage up off the base at a distance. In these embodiments, the distance can be larger than the height of the vessel. Accordingly, in embodiments in which the vessel drops away from the dispenser under the force of gravity, the carriage will not be in the way of a robotic end effector that needs to retrieve the vessel from the dispenser. In specific embodiments of the invention, the base can include a depression that helps to stabilize the vessel when it falls in order to prevent the vessel from tipping when it drops. The depression can have an opening that exceeds a cross section of the bottom of the vessel by a wide margin and that narrows down to closer to said cross section, to the point of forming a form fit, in order to funnel the vessel towards a position of stability in the depression.

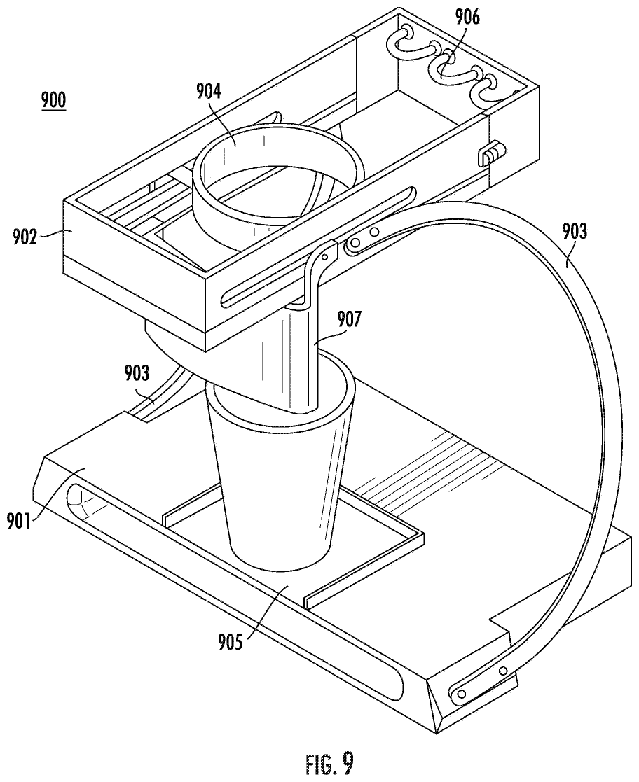

FIG. 9 illustrates a perspective view of a device 900 for dispensing a vessel in accordance with specific embodiments of the invention disclosed herein. Device 900 includes a base 901 located below a carriage 902 by a distance. As illustrated, the distance is larger than a height of the vessel. In the illustrated approach, the carriage 902 is held off base 901 using legs 903 and vessel stabilizer 904. More specifically, the legs 903 are attached to a support for vessel stabilizer 904 and the support forms part of the slide track of carriage 902. Carriage 902 can have the characteristics of the carriage in FIGS. 7 and 8. A stack of vessels can be placed in vessel stabilizer 904, and individual vessels can be depressed at each actuation of carriage 902. The vessels can then fall into a depression 905 in base 901.

FIG. 9 additionally illustrates a set of anchors 906 which can be connected to vessel stabilizer 904 via an elastic actuator. Set of anchors 906 are connected to carriage 902 and therefore move with carriage 902 when actuated. Vessel stabilizer 904, in contrast is connected to legs 903 via a support and does not move when carriage 902 is actuated. As a result, the elastic actuator can be stretched when the carriage is moved from a start point to an end point and can then automatically retract the carriage back to the start point when the force applied to actuate the carriage is released. In alternative embodiments, the elastic member could alternatively connect any portion of the device that does not translate with the carriage with portions that do translate with the carriage.

FIG. 9 additionally illustrates a guard 907 that is attached to legs 903. The guard 907 also does not translate when the carriage is actuated. The guard 907 can be used to increase the usability of the device for a robot with limited finesse in that it can provide a strong stop to the application of force against the carriage and can also block the stack of vessels hanging under the carriage from being pushed and potentially ripped out of the dispenser before they are ready. In alternative embodiments, the guard 907 could alternatively be connected to any portion of the device that does not translate with the carriage or could translate with the carriage and still protect the hanging vessels so long as the carriage is provided with a strong end point stop.

In specific embodiments of the invention, a device using the two platforms mentioned elsewhere herein, which includes a gap used to dispense a vessel from a dispenser can, can be augmented to include an elastic element positioned across the gap. The elastic element can be configured to have a higher degree of flexibility in one direction as compared to the other. The two directions can be along the range of motion of the slide track. In specific embodiments, the elastic element can be configured to more easily allow for the release of a vessel. In specific embodiments of the invention, the elastic element can be flexible in only one direction along the slide track. In specific embodiments of the invention, the elastic element can assure that a vessel is fully released from the vessel stack in that it is allowed to loosen from the vessel stack when the carriage is actuated from the start position to the end position, but is not allowed to be pushed back onto the vessel stack when the carriage is actuated back to the start position from the end position. In specific embodiments of the invention, the elastic element can be a flexible metal or plastic clip which is placed across the gap and shaped to prevent flexing in one direction and allow flexing in the other direction.

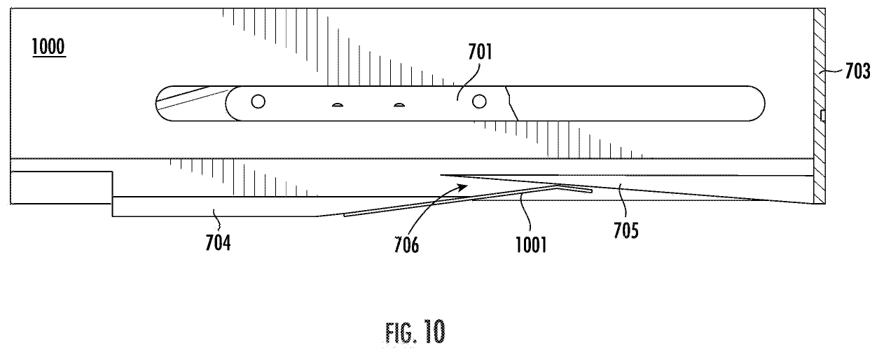

FIG. 10 illustrates a cross section of a carriage 1000 of a device for dispensing a vessel with a clip 1001 spanning a gap 706 between a first platform 704 and a second platform 705 in accordance with specific embodiments of the invention disclosed herein. As shown clip 1001 is a flexible metal clip and has been placed across the gap 706 and shaped to prevent flexing in one direction and allow flexing in the other direction. As a result, as a vessel is partially separated from the vessel stack by platform 705 as force is applied on surface 703, the clip will bend downward and out of place. Subsequently, the clip 1001 will snap back into place and will not bend upward as the device resets. As a result, the vessel will be forcibly separated from the vessel stack as opposed to being forced back onto the stack through gap 706.

In specific embodiments of the invention, a device for dispensing vessels can be marked by an encoding to make it more easily detectible and manipulatable by a robot. The device can include a carriage with an actuation portion such as the flat target mentioned elsewhere herein. The actuation portion can be marked by an encoding that can be detected by a computer vision system of the robot. The actuation portion and the encoding can be located on a front face of the device such that the same encoding can be prominently presented for navigating to the vessel dispenser and actuating the vessel dispenser. The encoding can be a light sensor detectible encoding. In specific embodiments of the invention, the encoding could be configured for easy detection by a computer vision system. For example, the encoding could be monochromatic and could have few edges. The encoding could be a two-dimensional encoding. The encoding could be encoded in variant spatial patterns of black and white. The visual flags could be AprilTags, QR Barcodes, Aztec, MaxiCode, Data Matrix or ArUco markers. The encoding could be detectible by a visible light sensor, an ultraviolet light sensor, or an infrared light sensor.

With reference back to FIG. 6, the vessel dispenser 603 includes an encoding 604 in the form of a sticker with a two-dimensional monochromatic pattern. The pattern can inform a robotic vision system both where the actuator is for the vessel dispenser 603, what vessel dispenser 603 is, and what kind of action is required to actuate the vessel dispenser 603. As illustrated, a robot has already used end effector 601 to retrieve vessel 503 from vessel dispenser 603 and has subsequently navigated to fill station 600 and placed vessel 503 on platform 101. The robot can be aided in this action by encoding 602 which can be of the same type as encoding 604. However, the encodings are different such that the robot can recognize one indicates the presence of a dispenser and the other indicates that the fill station includes a full vessel. The robot can be programmed to retrieve vessel 503 from vessel dispenser 603 as a subtask of retrieving fill material from fill station 600. The robot can be programmed to operate the vessel dispenser 603 and pick up the vessel 503 using the same appendage as is used to operate the fill station 600 (e.g., end effector 601 in the illustrated case).

In specific embodiments of the invention, a fill station dispenser is augmented with a device to facilitate robotic interaction. Such a device can be referred to as an augmentation. The fill station dispenser can be a faucet tap such as a standard water cooler tap. The standard water cooler tap is extremely common and is used across most water dispensers and jugs in the United States. The fill station dispenser may be configured to be depressed or lifted in order to engage a flow of the fill material. The device therefore provides certain benefits in that standard fill station dispensers may otherwise be too small or difficult to manipulate. The device can be configured to increase the surface area used to engage the dispenser. The device can be configured to provide an adapter which renders the dispenser easier to grip. The device can be configured to render the dispenser more easily detectible by a computer vision system used to pilot the robot or manipulate the robotic end effector which will engage the dispenser.

In specific embodiments of the invention, the device is configured to be connected to a fill station dispenser. The fill station dispenser can include a faucet tap on a standard water cooler. The device can include a means for connecting for this purpose. The means for connecting can be a clip, adhesive, fastener (e.g., screw, bolt, nail, tack), latch, catch, clasp, buckle, or any other means for connecting two elements. In specific embodiments, the connection can be formed without using any tools and can prevent any permanent damage or modification to the fill station dispenser. The device can thereby be used to easily and non-permanently modify a standard fill station dispenser when it is desired to augment the fill station for robotic interaction and return the dispenser to its standard state by removing the device. In specific embodiments of the invention, the device can be available in multiple colors to match that of the dispenser it is intended for and to blend in with the dispenser. For example, the device could be available in a blue color to match with cold water dispensers that are also colored blue, or a red color to match with hot water dispensers that are also colored red. In specific embodiments of the invention, the device can include a clip configured to connect to a fill station dispenser. If the fill station dispenser is a faucet, such a device can be referred to as a faucet clip. The clip can include a main body, a first clip jaw, and a second clip jaw. The main body can be planar. The main body, first clip jaw, and second clip jaw can be sized to attach the device to a fill station dispenser. The planar main body can be configured to closely align with a main planar surface of the fill station dispenser (e.g., the top planar surface of a standard water cooler tap). In specific embodiments of the invention, the main body, first clip jaw, and second clip jaw, are a single static unitary element of material such as a static plastic element formed via a molding process or additive manufacturing process. In alternative embodiments of the invention, the main body can be a non-static element extendible to fit a set of fill station dispensers with different dimensions.

In specific embodiments of the invention, the devices disclosed herein can include a handle attached to a means for connecting. The handle can be provided to increase the surface area used to engage the dispenser. The handle can alternatively or in combination include an adapter to mate with a robotic end effector designed to actuate the dispenser. The handle can be aligned with a main body of the means for connecting, such as the main planar body of a clip. The handle can form a substantially continuous surface with the means for connecting to provide a large target for robotic interaction. In specific embodiments of the invention, the handle can be wider than the means for connecting and include an adapter for robotic interaction.

In specific embodiments of the invention in which the device includes a clip, the device can be configured to prevent actuation of the handle from disengaging the clip. For example, if the fill dispenser is engaged by forcing the dispenser in a downward direction, force applied to the handle in a downward direction could compress at least one of the clip jaws towards the dispenser. As such, the main force applied to the handle from a robot, which may not be able to delicately calibrate the amount of force applied to the device, would not result in a loosening or outright disengagement of the clip.

In specific embodiments of the invention, in which a device includes a clip with a first clip jaw, a handle on the device can be positioned to exert, when actuated, a force that compresses the first clip jaw. In specific embodiments of the invention, the handle is attached to an outside edge of one of the clip jaws such that actuating the handle compresses the clip jaw towards the dispenser. The clip jaw could wrap around a top side of the dispenser for dispensers that are downwardly actuated and could wrap around a bottom side of the dispenser for dispensers that are upwardly actuated. In specific embodiments, the clip includes a substantially planar main body that is in contact with a top side of the dispenser such that force applied to depress the dispenser more strongly connects the clip with the dispenser. In embodiments in which the handle is actuated in an upwards direction, the clip can be configured to have the body in contact with a bottom side of the dispenser for the same reason. In specific embodiments of the invention, the main body of the clip separates one end of the clip from the other by at least five millimeters. In these embodiments, force that is applied to the handle will be absorbed by contact between the main body and the dispenser before being applied to the alternative clip jaw.

In specific embodiments of the invention, the handle of the device can include an adapter to facilitate robotic interaction. The adapter can be complementary to a robotic end effector (e.g., a loop formed to match a hook on a robotic end effector. The adapter could also include a divot to receive a shaped portion of a robotic end effector such that when the end effector is placed into contact with the handle it finds purchase and is less able to slip off the handle when the effector applies force to actuate the dispenser. In specific embodiments of the invention, the divot can be made relatively large compared to the dispenser itself in order to maximize the area capable of interacting with the robot and to make targeting of the handle easier. In specific embodiments the divot is wider than the dispenser itself. In specific embodiments of the invention, the handle is wider than the dispenser. In specific embodiments of the invention, the handle includes a divot that covers a majority of a main surface of the handle.

In specific embodiments of the invention, the device includes a stabilizer. The stabilizer can be configured to maintain the clip in place while the dispenser is actuated. The stabilizer can be attached to the clip. The stabilizer can be attached to the clip on an opposite end from the handle. In specific embodiments of the invention, the stabilizer can be configured to form a bracket with the fill station. In specific embodiments of the invention, the stabilizer can have a u-shape and include two prongs that are in contact with either side of the fill station dispenser. The prongs of the u-shape can be longer than the range of motion of the dispenser relative to the static portions of the fill station such that they can remain in contact with the fill station while the dispenser is actuated and still continued to provide a stabilizing force through the full range of motion of the dispenser. The stabilizer can keep the clip from moving off axis relative to the direction of actuation of the dispenser. In specific embodiments, this can provide significant benefits in that a robotic end effector may apply force in an un-even manner as compared to the direction in which the dispenser is intended to be actuated. The stabilizer can then counteract this force and prevent the device from being inadvertently loosened or disconnected from the fill station.

In specific embodiments of the invention in which the device includes a stabilizer, the stabilizer can be hinged. The hinge of the stabilizer can be used to rotate the stabilizer away from the fill station in order to allow for the device to be easily connected and removed. The hinge can also allow for the adjustment of the length of a bracket formed by the stabilizer to avoid any excess length of the prongs interfering with the operation of the fill station. The hinge can connect the stabilizer to an end of the main body of the clip. In specific embodiments of the invention, the hinge can be separated along the extent of the main body of the clip from the second clip jaw such that force applied to the stabilizer is not directly transferred to the second clip jaw.

In specific embodiments of the invention, the device can include a target holder to facilitate robotic interaction. The target holder can display a pattern, symbol, or encoding that informs a robotic computer vision system where the device is located and can optionally inform the robotic computer vision system what the device is. For example, the target could be an encoding of a code recognized by the robot to represent a fill station dispenser and the motion of actuation required to operate the dispenser (e.g., Downward-Push-Type Water Cooler Faucet Tap). The target holder can be configured to be easily visible to a robotic computer vision system that is positioned to interact with the fill station dispenser. For example, if the handle were configured for actuation in a predominately up or down direction, the target holder could form a greater than 45° angle with the handle and be positioned to be viewed from a direct front view of the fill station. The target holder could be a square element of material attached to the handle and the target could be a sticker attached to the target holder.

The target holder could be configured to hold a target in the form of an etched or adhered target. A robot could then use the target to interact with the fill station. The robot could include a visible light sensor or a depth sensor in order to detect the target and respond thereto. In specific embodiments of the invention, the target could be configured for easy detection by a computer vision system. For example, the target could be monochromatic and could have few edges. The target could be a two-dimensional encoding. The encoding could be encoded in variant spatial patterns of black and white. For example, the target holder could be a square element of material attached to the handle and the target could be a sticker attached to the target holder. The target could be a sticker with a two-dimensional pattern that can be detected by a light sensor in the form of a visible, ultra-violet, or infrared light sensor. The two-dimensional pattern could be in the form of an AprilTag, QR Barcode, Aztec, MaxiCode, Data Matrix or ArUco marker.

In specific embodiments of the invention, the device can be formed using various approaches. In embodiments in which the device includes a clip, the elements can be formed of plastic, silicon, rubber, or any other material that can support the action of a clip jaw. In specific embodiments of the invention, the device can be formed using one or more molds or one or more rounds of additive manufacturing. The clip jaw can be provided by a pliant portion of the device shaped to provide tension when clipped, or by an embedded component such as a spring that maintains tension when clipped. The elements of the device could be separately formed and then adhered together or comprise a single unitary element. The elements could be formed using a single mold, a co-injection molding process, or an over molding process. The elements could also be adhered together using adhesive, welding (e.g., heat or sonic), or any other form of connecting elements. In specific embodiments, the clip and handle form a single unitary element. In specific embodiments, the clip, handle, and target holder form a single unitary element. For example, the elements could be formed using injection molding.

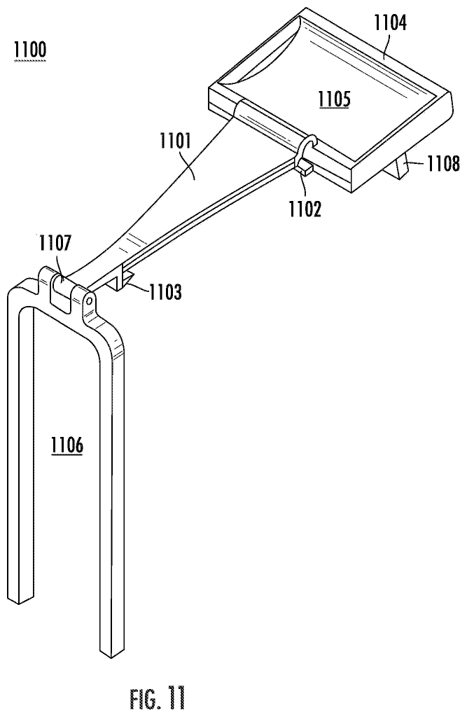

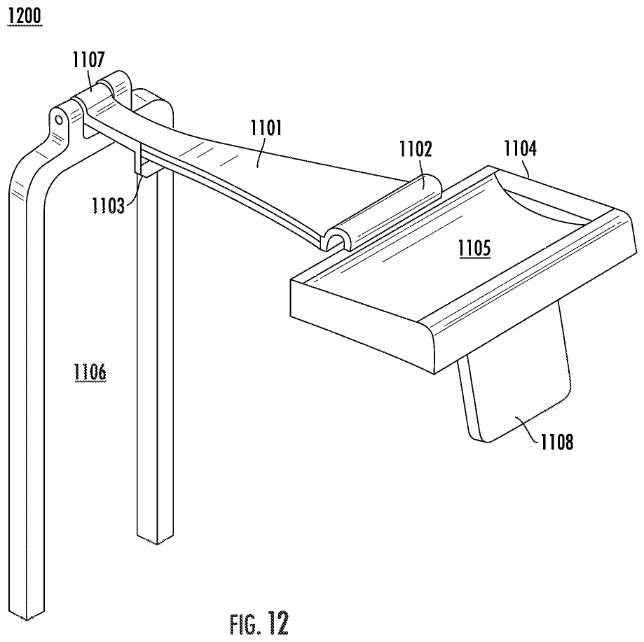

FIG. 11 includes a perspective view 1100 of a faucet clip for robotic interaction that is in accordance with specific embodiments of the invention disclosed herein. FIG. 12 includes a second perspective view 1200 of the faucet clip in FIG. 11. Each perspective view shows main body 1101 with a first clip jaw 1102 and second clip jaw 1103. The main body 1101 is substantially planner and spaces apart first clip jaw 1102 from second clip jaw 1103 by approximately 39 millimeters. The faucet clip also includes handle 1104 with a divot 1105. Divot 1105 comprises a majority of the main surface area of handle 1104. Divot 1105 is also rounded to fit an exterior portion of a robotic end effector. However, in specific embodiments of the invention, the divot can take on any shape upon which a robotic end effector can find purchase. The faucet clip also includes a stabilizer 1106 in a u-shaped as formed by two prongs. As shown, stabilizer 1106 includes a hinge 1107 attaching the stabilizer to the main clip body 1101.

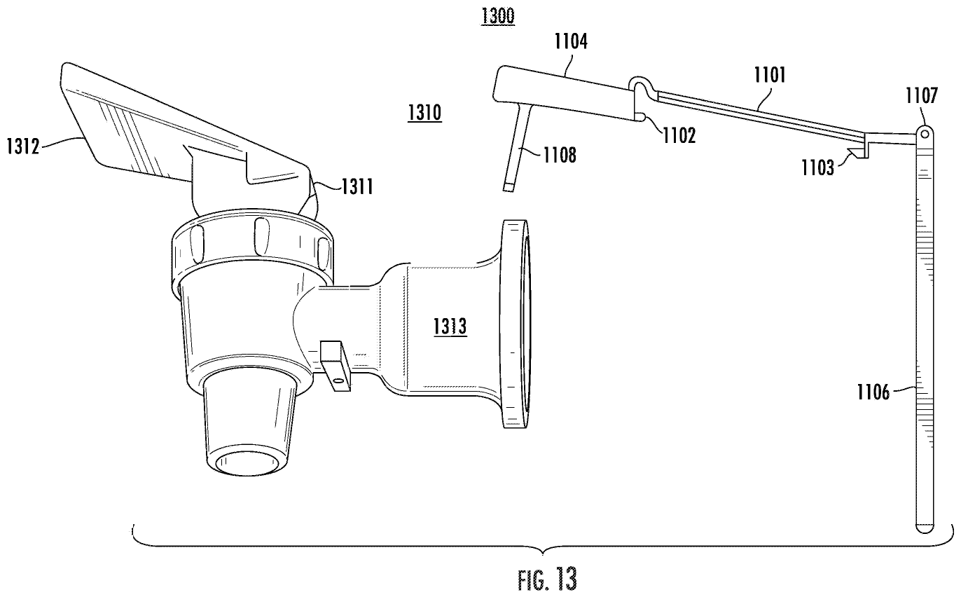

FIG. 13 includes a side view of the faucet clip 1300 in FIG. 1 along with a standard water cooler tap 1310 to illustrate the interconnection of the two in accordance with specific embodiments of the invention disclosed herein. The standard water cooler tap 1310 is an example of a fill station dispenser that the devices disclosed herein can be connected to. As shown, first clipping jaw 1102 is designed to attach to dispenser edge 1312 and second clip jaw 1103 is designed to attach to dispenser edge 1311. Furthermore, stabilizer 1106 is formed to bracket and remain in contact with dispenser neck 1313. The prongs of stabilizer 1106 are long enough to remain in contact with dispenser neck 1313 through the full range of motion that the dispenser can engage in when depressed and released.

The faucet clip illustrated in FIGS. 11-13 is configured to remain attached to faucet tap 1310 in various ways. As mentioned, stabilizer 1106 brackets dispenser neck 1313. As a result, even if force is applied to the faucet tap in an uneven manner by a robot with less than perfect finesse, the clip will not experience a torsion force that might have otherwise disconnected the clip. Furthermore, since handle 1104 is attached to an outside edge of first clip jaw 1102, when the dispenser is engaged by actuating handle 1104 in a downward direction, first clip jaw 1102 is compressed against the dispenser and the clipping force is strengthened as opposed to being disrupted. Furthermore, since the dispenser is one which is engaged by pressing down on the dispenser, the clip is designed to be placed on the top of the tap so that a downward force pushes it against the dispenser as opposed to pulling it away. Furthermore, since the main body of the clip is in contact with the top surface of the tap along the entire length of the tap, the tap and clip absorb any force that otherwise may have lifted clip 1103 up and disengaged the back side of the clip from the faucet. The clip itself can therefore remain pliant and easy to connect while the stiffness of the faucet tap absorbs the force of actuation. Although the length of the main clip body is set to meet the length of standard faucet taps, similar fill station dispensers that are actuated via a downward or upward motion can utilize the same effect. The applicants have found that in applications in which the force required to engage the dispenser is equivalent to standard devices that are configured for standard consumer-grade unassisted human manipulation, a length greater than 5 millimeters is critical for avoiding an action in which the back side clipping jaw is effected by actuation of a the tap. The benefits described in this paragraph can also be realized for upwardly actuated dispensers by attaching the clip on the bottom side of the dispenser. In specific embodiments in which the stabilizer is hinged, the stabilizer can optionally be rotated to face the alternative direction or be kept in the same direction around the hinge based on the layout of the dispenser itself.

The device illustrated in FIGS. 11-13 is configured for robotic interaction through use of target mount 1108. As illustrated, target mount 1108 forms a greater than 45° angle with handle 1104. In the figure, the angle is close to 90°. As a result, a target placed on target mount 1108 is readily viewable when the device is used to augment a tap that is actuated via a downward force. As shown in FIGS. 5 and 6, target mount 1108 can be used to mount a sticker with a two-dimensional encoding to allow a robot to find and interact with the fill station dispenser.

FIG. 5 illustrates a fill station 500 where the fill material is potable water in a water tank 501 that has been augmented with a dispenser in the form of a faucet clip 502 for robotic interaction in accordance with specific embodiments of the invention disclosed herein. The augmentation renders the dispenser of water tank 501 more easily manipulated by a robotic gripper and includes an encoding 504 used to mark the dispenser. Encoding 504 is in the form of a sticker that a computer vision system of a robot can find, recognize, and lock on to in order to align the gripper with the dispenser. The figure also shows a vessel 503 that has been placed to receive the fill material. The robot could be configured to place vessel 503 at the fill station and engage the dispenser using faucet clip 502 using the same end effector. As shown, the faucet is off, the handle is not depressed, and the stabilizer 505 is therefore at its lowest point relative to the dispenser. The fill station also includes a mechanism for metering the dispensing of fill material from the fill station which is in accordance with this disclosure and the disclosure in U.S. Patent Application No. 62/952,992 filed on Dec. 23, 2019, and incorporated by reference herein in its entirety for all purposes.

FIG. 6 illustrates a faucet clip 502 being used by a robotic end effector 601 to actuate a fill station 600 dispenser in accordance with specific embodiments of the invention disclosed herein. FIG. 6 includes fill station 600, robotic end effector 601, and vessel dispenser 603 in accordance with specific embodiments of the invention disclosed herein. As illustrated, the fill station 600 is in accordance with the fill station of FIG. 5 as augmented by the device in FIG. 11. However, FIG. 6 also illustrates an encoding 602 in the form of a sticker which indicates to a computer vision system the location of the platform of the fill station. In specific embodiments of the invention, a mobile robot with control of end effector 601 will be programmed to use that same appendage to both operate the dispenser via the faucet clip 502 and to place vessel 503 on the platform. The mobile robot can use encoding 602 in order to guide that placement. As illustrated encoding 602 and the encoding on target 504 are of the same kind and are configured for use by the same computer vision system. As illustrated, end effector 601 does not grip and depress the dispenser as the required range of motion required for such an action is fairly precise. Instead, the robot finds purchase in the divot of the handle of the faucet clip 502 and pushes down on the top of the handle. The stabilizer 405 helps to keep the clip in place despite the fact that the downward force of robotic end effector 601 might not be symmetrically applied.

In addition to placing a vessel at the station and engaging the dispenser, a robot can be programmed to retrieve a vessel from a dispenser as a subtask of retrieving fill material from a fill station. As illustrated, the mobile robot can retrieve a vessel 503 in the form of a cup from a vessel dispenser 603 in the form of a cup dispenser. The vessel dispenser 603 can include an encoding 604 in order to provide the robot with a target to operate vessel dispenser 603. Encoding 604 and 602 can be of the same type as the encoding on target 504. The robot can be programmed to operate the vessel dispenser and pick up the vessel using the same appendage as is used to operate the fill station (e.g., end effector 601 in the illustrated case).

While the specification has been described in detail with respect to specific embodiments of the invention, it will be appreciated that those skilled in the art, upon attaining an understanding of the foregoing, may readily conceive of alterations to, variations of, and equivalents to these embodiments. Any element that requires robotic interaction can be marked with encodings, symbols, or patterns to help the robot find and interact with those elements. The markings can be detectable using a visible light sensor or a light sensor in the ultra-violet or infrared range. The markings can be on stickers or can comprise specialized inks or materials that differ from their surroundings. The markings can be fiducial markers. Although examples in the disclosure where generally directed to a mobile robot used to navigate to a fill station, navigate to a vessel dispenser and to actuate the dispenser, different robotic systems could serve to actuate the dispenser, meter the fill material and navigate to and from the fill station and/or vessel dispenser. Although examples in the disclosure where generally directed to the benefits provided by the devices herein to facilitate interaction with robotic users, human users, and in particular disabled human users, could also benefit from the devices disclosed herein. Although examples in the disclosure were generally directed to the application of dispensing vessels in the form of lipped cups, the approaches disclosed herein can be applied to the dispensing of any item from a stack of items where the items include a feature with a larger surface area and where the feature is prominent even when the vessel is in a stack. These and other modifications and variations to the present invention may be practiced by those skilled in the art, without departing from the scope of the present invention, which is more particularly set forth in the appended claims.

What is claimed is:

1. A method for robotic retrieval of a fill material comprising:
navigating a robot to a fill station, wherein the fill station includes a scale and contains the fill material;
placing, using the robot, a vessel on the scale;
engaging, with the robot, a dispenser of the fill station;
triggering, when a weight of the vessel as measured by the scale reaches a target weight, a flag;
disengaging, with the robot and in response to the flag, the dispenser of the fill station; and
retrieving, using the robot, the vessel from the scale.

2. The method of claim 1, wherein:
the vessel is a drink container; and
the fill material is a liquid.

3. The method of claim 1, wherein:
the robot executes the placing and the engaging steps using a single appendage.

4. The method of claim 1, wherein:
the flag is a visual flag on the fill station; and
the robot has a visual light sensor to respond to the flag.

5. The method of claim 4, wherein:
the flag is a mechanical flag.

6. The method of claim 1, wherein:
the flag is a wireless flag transmitted by a wireless transmitter of the fill station; and
the robot has a wireless receiver to respond to the flag.

7. The method of claim 6, wherein triggering the flag comprises:
depressing the scale in a motion;
closing a circuit using the motion; and
wherein the circuit is communicatively connected to the wireless transmitter.

8. The method of claim 1, wherein:
the scale is a mechanical scale; and
the flag is a mechanical flag translated by the scale.

9. The method of claim 8, wherein triggering the flag comprises:
depressing the scale in a motion; and
mechanically translating the flag using the motion.

10. The method of claim 8, wherein:
the flag includes a two-dimensional encoding.

11. The method of claim 8, wherein:
the dispenser of the fill station is marked by a second flag; and
the flag and the second flag are of a same type.

12. The method of claim 8, further comprising:
navigating a robot to a cup dispenser;
retrieving, using the robot, the vessel from the cup dispenser;
wherein the cup dispenser is marked by a second flag; and
the flag and the second flag are of a same type.

13. A device comprising:
a mechanical scale for holding a vessel; and
a visual flag translated by the mechanical scale;
wherein the visual flag is hidden when the vessel is below a target weight; and
wherein the visual flag is revealed when the vessel is above a target weight.

14. A system comprising:
a robot with a visible light sensor and an end effector;
a mechanical scale for holding a vessel; and
a visual flag translated by the mechanical scale;
wherein the visual flag is hidden when the vessel is below a target weight;
wherein the visual flag is revealed when the vessel is above a target weight; and
wherein the robot is programmed to detect the visual flag using the visible light sensor and, disengage a dispenser in response to the detecting of the visual flag.

15. The system of claim 14, wherein:
the visual flag is monochromatic.

16. The system of claim 14, wherein:
the visual flag is a two-dimensional encoding.

17. The system of claim 14, further comprising:
a mechanical calibrator configured to set the target weight.

18. The system of claim 14, wherein:
the robot is mobile; and
the robot is programmed to: (i) navigate to the mechanical scale; and (ii) place the vessel on the mechanical scale.

19. The system of claim 14, wherein:
the vessel is a drink container; and
the dispenser is a liquid dispenser.

20. The system of claim 14, further comprising:
an appendage on the robot; and
wherein the robot is programmed to: (i) disengage the dispenser using the appendage; and (ii) place the vessel on the mechanical scale using the appendage.

21. The system of claim 14, wherein:
the mechanical scale is compressed via a motion; and
the visual flag is translated using the motion.

22. The system of claim 14, further comprising:
a second flag on the dispenser; and
wherein the robot is programmed to find the dispenser using the second flag.

23. The system of claim of claim 14, further comprising:
a cup dispenser;
a second flag on the cup dispenser;
wherein the robot is programmed to retrieve the vessel from the cup dispenser; and
wherein the robot is programmed to find the cup dispenser using the second flag.
